(19) United States
(12) Patent Application Publication
(10) Pub. No.: US 2017/0327038 A1
(43) Pub. Date: Nov. 16, 2017

(54) IMAGE PROCESS BASED, DYNAMICALLY ADJUSTING VEHICLE SURVEILLANCE SYSTEM FOR INTERSECTION TRAFFIC

(71) Applicant: Razmik KARABED, San Jose, CA (US)

(72) Inventor: Razmik KARABED, San Jose, CA (US)

(21) Appl. No.: 15/155,337

(22) Filed: May 16, 2016

Related U.S. Application Data
(60) Provisional application No. 62/334,314, filed on May 10, 2016.

(51) Int. Cl. B60R 1/00; H04N 7/18; G06K 9/00; H04N 5/14; B60Q 1/34; G01S 19/13; H04N 5/232

(52) U.S. Cl. CPC B60R 1/00; H04N 7/188; H04N 7/181; H04N 5/23293; H04N 5/144; B60Q 1/343; G01S 19/13; G06K 9/00798; B60R 2300/303; B60R 2300/105; B60R 2300/802

(57) ABSTRACT

A dynamically adjusting surveillance system provides a monitor, a sequence of views that include a key view. The sequence of views is captured by a camera. The monitor can display a portion of the camera view. The system is configured such that the displayed portion of the camera view includes the key view to a driver of the vehicle. The key view can be selected to be a rearward view when the vehicle is not turning, and a view of cross traffic from a side opposite which a turn is made at an intersection.

### CROSS-REFERENCE TO RELATED APPLICATIONS

This application claims the benefit of priority to U.S. provisional patent application No. 62/334,314, filed May 10, 2016, the contents of which are herein incorporated by reference.

### BACKGROUND OF THE INVENTION

### 1. Field of the Invention

One or more embodiments of the invention relates generally to surveillance devices and methods. More particularly, embodiments of the present invention relate to dynamically adjusting surveillance systems that can, for example, assist a driver when crossing intersections.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

A large number of car crashes is due to a lack of adequate surveillance during turns at intersections. According to the U.S. Department of Transportation, National Highway Traffic Safety Administration (NHTSA), DOT HS 811 366, September 2010, entitled “Crash Factors in Intersection-Related Crashes: An On-Scene Perspective”, among 12 critical pre-crash events, a vehicle turning left at an intersection is number one, being present in 22.2% of all crashes. Inadequate surveillance is the number one driver attributed critical reason of intersection-related crashes.

Thus improving surveillance at intersections will reduce car crashes significantly. During turns, views provided by traditional car side mirrors are not directed toward areas that the car is the most vulnerable, as explained below.

The proper use of right-side and left-side mirrors is a necessary driving skill. These mirrors provide great help to a driver in making many important driving decisions. Nevertheless, during a typical left or right turn, except at the start and at the end of the turn, these mirrors provide views that, in general, are not the most helpful. A study of the following situations confirms the above assertion. There are four scenarios including A1) right side mirror during a left turn; A2) right-side mirror during a right turn; A3) left-side mirror during a left turn; and A4) left-side mirror during a right turn.

With respect to scenario A1 (right-side mirror during a left turn) and referring to FIG. 1, an automobile 4 is depicted in three positions: facing north at an intersection 5 (position 22), facing north-west in the intersection 5 (position 23), and facing west past the intersection 5 (position 24). The automobile 4 has a right-side mirror 1 and a left-side mirror 2. At the start of the turn, the mirrors 1, 2 are all showing views facing south. The right-side mirror 1 is showing a view south from the right side of the automobile 4, and the left-side mirror 2 is showing a view south from the left side of the automobile 4. At the end of the left turn, the mirrors 1, 2 are showing views facing east. However, during the left turn in the intersection 5, the mirrors 1, 2 are mostly showing views of the surroundings at the south/east corner of the intersection 5. In general, these views are not the most helpful. Views of the two streets would be more helpful since they would show nearby automobiles.

With respect to scenario A2 (right-side mirror during a right turn) and referring to FIG. 2, the automobile 4 is depicted again in three positions: facing north at the intersection 5 (position 22), facing north-east in the intersection 5 (position 25), and facing east past the intersection 5 (position 26). Again, at the start of the turn, the mirrors 1, 2 are all showing views facing south. At the end of the right turn, the mirrors 1, 2 are showing views facing west. However, during the right turn in the intersection 5, the mirrors 1, 2 are mostly showing views of the surroundings at the south/west corner of the intersection 5. Again, in general, these views are not the most helpful since they show a portion of the street which carries cars going south, past the intersection 5.

With respect to scenario A3 (left-side mirror during a left turn), the analysis uses the same logic as scenario A2, except that the rotational polarities are reversed.

With respect to scenario A4 (left-side mirror during a right turn), the analysis uses the same logic as scenario A1, except that the rotational polarities are reversed.

Therefore, conventional side mirrors are not very helpful in providing surveillance during turns.

In conventional vehicle surveillance systems, to improve surveillance during turns, a sensor is used to measure the rotational position of the automobile. Position changes are then calculated by a controller and, based on the position changes, the mirrors are rotated to have views with more useful surveillance information.

As a television screen looks big when viewed from the front and it looks small when viewed from an angle, the viewing window of a side mirror varies as it rotates. Therefore, for some rotational angles, the viewing window of a side mirror becomes very small. Of course this only happens when the angles are big; nevertheless, there are situations when such large angles are desired. Hence, a disadvantage of some conventional solutions is that for some desired large rotational angles, the viewing windows of the side mirrors are small.

Some conventional devices rely on the determination of the rotational position of the vehicle. Some conventional devices rely on angular position sensors such as a digital compass, a tilt sensor, an accelerometer, a gyroscope, an odometer, a steering angular sensor, and the like. Use of angular position sensors generally results in 1) higher device cost, 2) higher installation cost, and 3) lower accuracy.

If the device has its own angular position sensors, then the cost of the device must include the sensors as well as the cost of connectors, but if the device uses existing sensors in the vehicle, then the cost of the device includes the cost of the connectors. In both cases, the use of the angular position sensors increases the cost.

If the device is using existing sensors in the vehicle and the device is installed during manufacturing, then there would be an increased installation cost. But if the device is using existing sensors in the vehicle and the device is installed as an after-market device, then again there would be a higher installation cost. Therefore, whether the product is installed during manufacturing of the vehicle or is installed as an after-market device, there is higher cost associated with the installation of the device.

The performance of some angular position sensors is subject to calibration errors and/or is subject to noise in the environment of a moving vehicle in traffic.

Accordingly, a need exists to improve dynamically adjusted surveillance systems.

### SUMMARY OF THE INVENTION

In accordance with the present invention, structures and associated methods are disclosed which address these needs and overcome the deficiencies of the prior art.

U.S. patent publication number 2015/0312530, the contents of which are herein incorporated by reference, offers the following solution to the issue of a significantly reduced viewing window. The mirror is replaced with a combination of a camera and a monitor, then, based on positional changes, the camera is dynamically rotated with a motor to capture useful views. The camera views are then displayed on the monitor without having to rotate the monitor and reduce its viewing window. The motor that rotates the camera is a major cost and a potential area for maintenance. Moreover, this conventional system uses an end switch and calibration process that is required with the motor driven camera.

U.S. patent application Ser. No. 14/677,839, filed Apr. 2, 2015, titled “Dynamically Adjusting Surveillance Devices”, and herein incorporated by reference, further makes the following modifications to the dynamically adjustable surveillance system. The device that rotates the camera, which usually is a motor, is eliminated. Instead it is required for the camera to have a wide enough angle lens. For a given position of the automobile at an intersection, only a portion of the camera view that is helpful is displayed on the monitor.

The advantages obtained over the conventional design include the following: 1) less cost. The device that rotates the camera in the conventional design is one of the major cost areas of the dynamically adjustable surveillance system; therefore, the elimination of the device that rotates the camera lowers the overall cost. This elimination makes the end switch used in the calibration of the conventional device useless, therefore further reducing cost. 2) Improved durability. Since the device that rotates the camera is the major moving part of the conventional surveillance device, it is the most susceptible to wear and tear. 3) Improved viewing quality. By eliminating the device that rotates the camera, the mechanical vibration associated with the conventional device is also eliminated.

Starting from U.S. patent application Ser. No. 14/677,839, the current application makes the following modifications to the dynamically adjustable surveillance system.

The angular position sensor, which usually is a digital compass, tilt sensors, an accelerometer, a gyroscope, an odometer, a steering angular sensor or a combination thereof, is eliminated, instead it is required that the angular position be generated from camera images via image processing techniques.

The advantages obtained over the conventional design include the following: 1) lower surveillance device cost, 2) lower installation cost, and 3) higher accuracy.

If the surveillance device is using its own angular position sensor, then by removing the angular sensor, its cost can be eliminated from the cost of the surveillance device. But if the surveillance device is using existing vehicle sensors, then by eliminating the need for the angular sensor, the cost of the connectors required to connect to the sensors can be eliminated from the cost of the surveillance device.

Again, if the device is using existing sensors in the vehicle and the device is installed during manufacturing, then by eliminating the need for the angular sensor, the installation cost associated with connections between the sensor and the surveillance device can be reduced.

But if the device is using existing sensors in the vehicle and the device is installed as an after-market device then similarly there would be lower installation cost. Therefore, whether the product is installed during manufacturing of the vehicle or is installed as an after-market device, there is lower cost associated with the installation of the device.

The task of connecting to sensors in a vehicle usually involves passing wires that reach inside the side-mirror housing, inside the doors, and inside the vehicle. Therefore, eliminating these connectors will reduce installation cost significantly.

The angular position generated by image processing techniques used here is not influenced by type of errors affecting angular sensors. A paper titled ‘IMU Errors and Their Effects’ by a leading company on position technology addresses errors affecting position measurements using angular sensors.

In a first aspect of the present invention, an image process based, dynamically adjusting vehicle surveillance system for intersection traffic is disclosed. The system includes a camera, a monitor, and a controller and memory unit.

The camera is configured for capturing a sequence of views that contain a desired key view. The sequence of camera views are index by integers: view(1), view(2), and so on.

The controller and memory unit is configured to receive the camera views; and at integer index, i=1, the controller and memory unit selects a subset, P1, of the view(1) that includes the key view, then it displays P1 on the monitor. The controller and memory unit further is configured to calculate changes in angular position of the vehicle by processing the camera views for integer indices i=2, 3, and so on. The controller and memory unit updates the selected subsets, P2, P3, and so on, of views view(2), view(3), and so on, respectively such that they include the key view.

Therefore, the monitor provides a driver of the vehicle with the desired key view.

The image process based, dynamically adjusting vehicle surveillance system for intersection traffic may use the following technique in calculation of changes in the angular position of the vehicle.

The controller and memory unit indexes the camera views by integers: view(1), view(2), and so on, then it takes a small portion, Q1, of pixels in a camera view at index i=1, view(1) and finds a best representative, Q2, in the camera view at index, 2, view(2). Next, the controller and memory unit measures the displacement from the Q1 portion to the Q2 portion. Finally, the controller and memory unit calculates a change in the angular position of the vehicle from index=1 to index=2 by based on the measured displacement.

In some embodiments, the small portion, Q1, of pixels in the camera view at time 1 may be selected at a close proximity of a vanishing point of view(1).

In a first exemplary embodiment, the key view typically is the same as view of a left-side mirror unless the vehicle is making a left turn at an intersection. Then the key view switches to include a view of a road section directed behind the vehicle on the left side before the turning is initiated. The key view typically is the same as view of a right-side mirror unless the vehicle is making a right turn at an intersection. Then the key view switches to include a view of a road section directed behind the vehicle on the right side before the turning is initiated.

The key view typically is the same as view of a left-side mirror unless the vehicle is making a right turn at an intersection. Then the key view switches to includes a view of a road section opposite to that of the road section into which the vehicle is turning—on other words, a view of the cross traffic from the left side.

The key view typically is the same as view of a right-side mirror unless the vehicle is making a left turn at an intersection. Then the key view switches to includes a view of a road section opposite to that of the road section into which the vehicle is turning—in other words, a view of the cross traffic from the right side.

The camera typically has a medium to wide angle lens.

In an exemplary embodiment, the system further includes a Global Positioning System (GPS) providing GPS signals to the controller and memory unit. The controller and memory unit typically terminates the dynamically adjusting surveillance system based on information from the GPS. The controller and memory unit typically updates the position of the selected subsets of the views, P's, based on side information from the GPS.

In another exemplary embodiment, the controller and memory unit changes the key views from typical side mirror views to views of the traffic in an intersection after detecting an intersection.

In one embodiment, the controller is designed to detect intersection as follows. An intersection is detected if both of the following conditions are satisfied: 1) total changes in the angular position of the vehicle exceeds a predetermined angle, for example 45 degrees, and 2) the controller and memory unit detects a change in the street lines indication entering an intersection.

In another exemplary embodiment, the system further includes side turn signal switches. In this embodiment, the controller is designed to detect intersection as follows. An intersection is detected if the controller and memory unit receives a turn signal from the side turn signal switch, and 2) the total changes in the angular position of the vehicle after receiving the turn signal exceeds a predetermined angle, for example 10 degrees.

Embodiments of the present invention provide a dynamically adjusting surveillance system comprising at least one camera configured to capture a sequence of views containing a key view; and a controller and memory unit configured to receive the sequence of views, the controller and memory unit further configured, based on the sequence of views, to measure changes in angular position of a vehicle using an image processing technique; wherein the controller and memory unit selects portions of the sequence of views based on a measured change in angular position of the vehicle, wherein the selected portions contain the key view.

Embodiments of the present invention further provide a dynamically adjusting surveillance system comprising at least one camera configured to capture a sequence of views containing a key view; a controller and memory unit configured to receive the sequence of views, the controller and memory unit further configured, based on the sequence of views, to measure changes in angular position of a vehicle using an image processing technique; and a monitor, wherein the controller and memory unit is further designed to display the selected portions of the sequence of views on the monitor; wherein the controller and memory unit selects portions of the sequence of views based on a measured change in angular position of the vehicle, wherein the selected portions contain the key view; wherein the key view is a rearward view when the vehicle is not turning and is a view of cross traffic from a side opposite which a turn is made at an intersection; and wherein the view of cross traffic is in a constant direction during the turn.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates conventional left and right side mirror views of a vehicle making a left turn;

FIG. 2 illustrates conventional left and right side mirror views of a vehicle making a right turn;

FIG. 3 illustrates a block diagram of an image processing based dynamically adjusting surveillance system in accordance with an exemplary embodiment of the present invention;

FIG. 4A illustrates a left-side mirror view before a vehicle reaches an intersection;

FIG. 4B illustrates a left-side mirror view when a vehicle is just crossing an intersection;

FIG. 5 illustrates an application of the image process based, dynamically adjusting vehicle surveillance system for intersection traffic in accordance with an exemplary embodiment of the present invention;

FIG. 6 illustrates a summary of the overall operation of the image process based, dynamically adjusting vehicle surveillance system for intersection traffic, in accordance with an exemplary embodiment of the present invention;

FIG. 7 illustrates a block diagram of an image process based, dynamically adjusting vehicle surveillance system for intersection traffic, in accordance with an exemplary embodiment of the present invention;

FIG. 8 illustrates a summary of the overall operation of the image process based, dynamically adjusting vehicle surveillance system for intersection traffic, including a side information detector, in accordance with an exemplary embodiment of the present invention;

FIG. 9 illustrates an application of the image process based, dynamically adjusting vehicle surveillance system for intersection traffic, according to another exemplary embodiment of the present invention;

FIG. 10 illustrates an application of the image process based, dynamically adjusting vehicle surveillance system for intersection traffic, according to another exemplary embodiment of the present invention; and

FIG. 11 illustrates an application of the image process based, dynamically adjusting vehicle surveillance system for intersection traffic, according to another exemplary embodiment of the present invention.

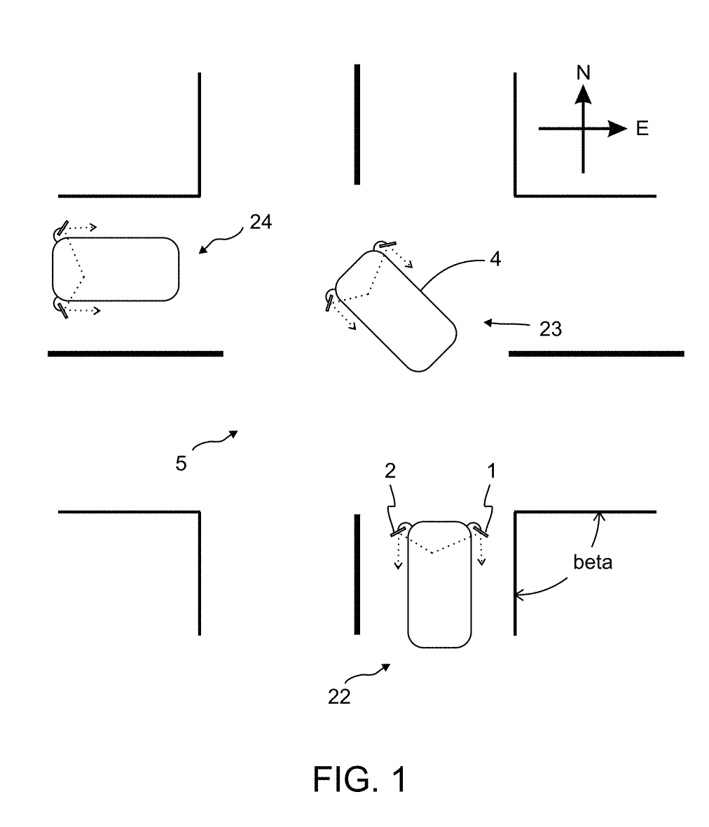

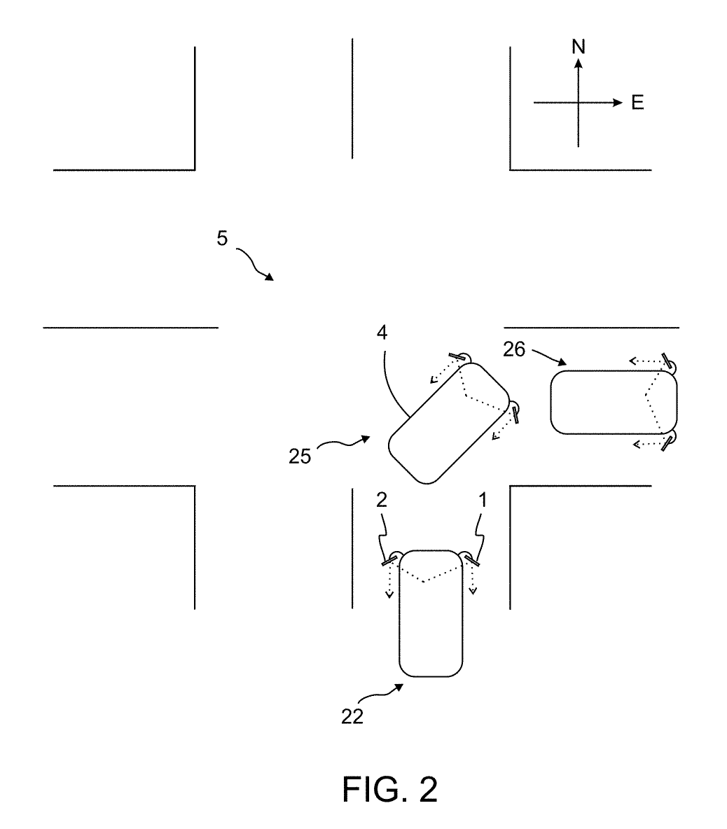

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

The present invention is described using various examples. Each example describes various situations and embodiments where the system of the present invention may be applied. The examples are used to describe specific incidents in which the present invention may be useful but is not meant to limit the present invention to such examples.

### EXAMPLE 1

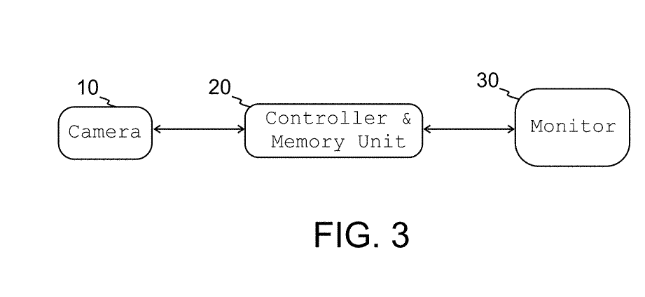

Example 1 is explained referring to FIGS. 3 through 6.

This example relates to scenario A4—referring to a view in the left-side mirror during a right turn. More specifically, an image process based, dynamically adjusting vehicle surveillance system for intersection traffic of Example 1 alleviates the shortcomings of the left-side mirror during right turns as explained earlier.

Here, the key desired view is a view of a left-side mirror when the vehicle is not turning right at an intersection, and the desired view is a view of a road section opposite to that of the road section into which the vehicle is turning; that is, a view of the cross traffic from the left side when the vehicle is turning right at an intersection.

FIG. 3 gives a block diagram of the image process based, dynamically adjusting vehicle surveillance system for intersection traffic. The image process based, dynamically adjusting vehicle surveillance system for intersection traffic includes a camera 10, a controller and memory unit 20, and a monitor 30.

The camera 10 may be placed on a side mirror housing, the controller and memory unit 20 may be affixed behind the monitor 30, and the monitor 30 may be placed in one or more of the following locations: 1) it may replace a side mirror, 2) it may be placed anywhere a GPS system is placed inside a vehicle, and 3) if a monitor already exists in the vehicle, it may be configured to act as the monitor 30.

Referring to FIG. 3, the camera 10 is configured to capture a sequence of views that contain the desired key view. The sequence of views of the camera 10 can be indexed in a natural way: view(1), view(2), and so on. Each of the views of the camera 10 contains a view of a left-side mirror, and because the camera 10 has a relatively wide angle the view extends to other areas.

The controller and memory unit 20 is configured to receive the sequence of the views: view(1), view(2) and so on.

When the vehicle is not making a right turn at an intersection, the controller and memory unit 20 selects portions P1, P2, and so on, of the views, view(1), view(2), so on, respectively, such that Pi's are views of a left-side mirror. Then the controller and memory unit 20 displays portions P1, P2, and so on, on the monitor 30. The monitor 30 provides these views to the driver of the vehicle. These views are sent as video to the monitor.

When the vehicle is making a right turn at an intersection, the controller and memory unit 20 selects portions P1, P2, and so on, of the views, view(1), view(2), so on, respectively, such that Pi's are views of cross traffic from the left side. Since the camera 10 has a lens with relatively wide angle, when the vehicle is making a right turn, the views view(1), view(2), and so on, include a view of the cross traffic from the left side. Therefore, selection of portions P1, P2, and so on, to include views of cross traffic from the left side is feasible.

Next, the controller and memory unit 20 displays portions P1, P2, and so on, on the monitor 30. The monitor 30 provides these views for the driver of the vehicle.

How the Pi potions are selected will be explained below.

### Angular Position Changes

The controller and memory unit 20 is configured to measure changes in angular position of the vehicle.

Consider the vehicle in two positions, first, the position of the vehicle when view(1) was captured by the camera 10, and second, the position of the vehicle when view(2) was captured.

In order to measure the angle between the first position and the second position of the vehicle the controller and memory unit 20 may perform the following.

The controller and memory unit 20 can take a small rectangular area, Q1, of size W×H pixels, where W, in pixels, is the width and H, in pixels, is the height of the area Q1 in the view(1) of the camera 10. Then, the controller and memory unit 20 finds a rectangular area, Q2, of the same size, in the view(2) of the camera 10 such that view(2), restricted to area Q2, is a best representation of view(1) restricted to area Q1.

Without loss of generality, one can assume that view(1) and view(2) are given in their RGB color format.

Then, view(1), restricted to area Q1, is given by a W×H×3 array, image1, where W is the width of the image, H is the height of the image; there are W×H pixels, and each pixel, (w,h), 0≦w≦W, 0≦h≦H, has 3 integers: image1(w,h,1)=r ∈ {0,1, . . . , 255}, image1(w,h,2)=g ∈ {0,1, . . . , 255}, and image1(w,h,3)=b ∈ {0,1, . . . , 255}, where r, g, and b are the levels of red, green, and blue of the pixel, respectively.

Similarly, view(2), restricted to area Q2, is given by a W×H×3 array, image2.

Now, the distance, D, between image1 and image2 can be defined as:

$$D = {\sum }_{w = 0}^{W} {\sum }_{h = 1}^{H} {\sum }_{c = 1}^{3} abs ( image 1 ( w , h , c ) - image 2 ( w , h , c ) ) ,$$

where abs denotes absolute value. View(2), restricted to area Q2, is a best representation of view(1), restricted to Q1, if for any other area, Q3, Q3≠Q2:

$$D \leq {\sum }_{w = 0}^{W} {\sum }_{h = 1}^{H} {\sum }_{c = 1}^{3} abs ( image 1 ( w , h , c ) - image 3 ( w , h , c ) ) ,$$

where view(2), restricted to area Q3, is given by a W×H×3 array, image3.

Next, the controller and memory unit 20 finds a pair of integers (ph,pv) such that if Q1 is moved horizontally by ph and then vertically by pv, then Q2 is obtained.

Now the difference in the angular position of the vehicle from its position when view(1) was taken to its position when view(2) was taken may be defined as ph. The unit here is number of pixels. An angular position difference of ph pixels may be stated in degrees (or radians) as follows: (angle of view horizontally of the camera 10, in degrees)*ph/(width of a view of the camera 10 in pixels).

Unless the vehicle is moving very fast, the difference in the angular position, ph, is small. Therefore the search for Q2 in view(2) can be reduced to the search for Q2 close to Q1 in view(2).

The difference in the angular position of the vehicle can be defined using other shaped areas instead of rectangle. The rectangle area was chosen as an example.

It should be noted that the small area Q1 in the view(1) of the camera 10 may be selected at close proximity of a vanishing point of view(1).

For all integers, n, n>1, the difference in the angular position of the vehicle from its position when view(n) was taken to its position when view(n+1) was taken is defined similar to case n=1 above.

How a right turn is detected will be explained below.

The controller and memory unit 20 is configured to detect the following two conditions.

1) Total changes in the angular position of the vehicle exceeds in magnitude a predetermined angle, alpha1, for example alpha1=45 degrees, and

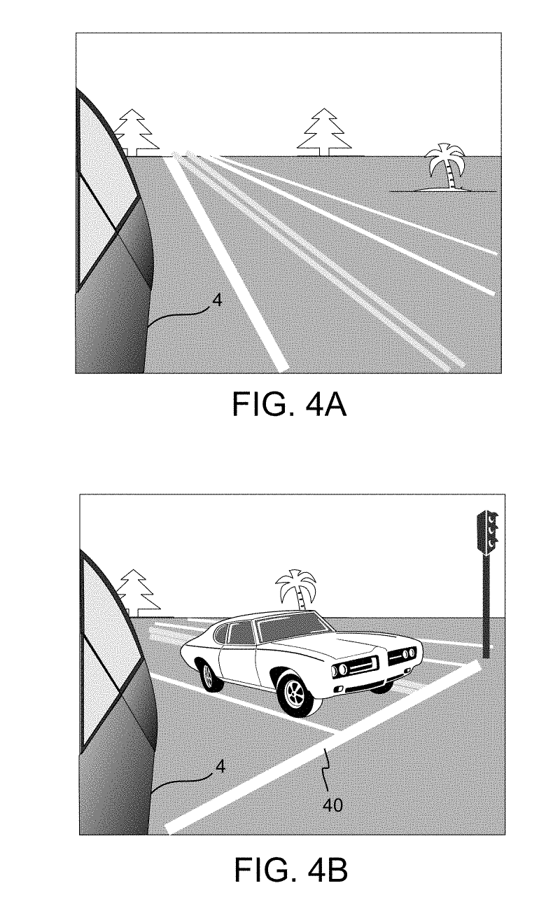

2) A change in the street lines indication entering an intersection. For example, FIG. 4A shows the left-side mirror view before the vehicle 4 reaches an intersection and FIG. 4B shows the left-side mirror view when the vehicle 4 is just crossing an intersection. A street line 40 is shown in FIG. 4B. The controller and memory unit 20 may, by noticing the line 40, detect the event that the vehicle is entering an intersection.

A right turn by the vehicle may be detected by the controller and memory unit 20 when one or both conditions above are detected.

The magnitude of the total changes in the angular position of the vehicle may grow without the vehicle making a right turn. For example, it may grow as the vehicle moves along a bendy road that gradually changes its direction, for example from toward north to toward east. This type of growth of the total changes in the angular position of the vehicle is not desirable since it may confuse the controller and memory unit 20 thinking the vehicle is in the process of a right turn. A good method that counters undesirable growth is to, for the purpose of detecting right turn, keep only the total changes over the last M views (or the last T seconds), where M (or T) is predetermined.

The condition 2) above prevents a sharp turn that is not part of a right turn to be marked as a right turn by the controller and memory unit 20. Nevertheless, since the vehicle does not encounter many sharp turns during normal driving conditions, the second condition may be eliminated. However, it has been kept in this example for extra accuracy.

### How to Select Portions (P1, P2, and so on)

When a right turn is not detected, more specifically, the controller and memory unit 20 selects P1=PA, P2=PA, so on, where PA is a predetermined area in the view of the camera 10 that corresponds to a view of a typical left-side mirror.

When a right turn is detected, more specifically, the controller and memory unit 20 first selects P1=PB, where PB is a predetermined area in the view(1) of the camera 10 that corresponds to a view of a typical cross traffic from left side from a vehicle that has completed alpha1 degrees rotation into its right turn.

After receiving view(2), the controller and memory unit 20 measures the change in angular position of the vehicle from position in view(1) to position in view(2). This change can be denoted by ph2. Next, the controller and memory unit 20 defines

P2=SHIFT(P1,ph2), that is the portion P2 is P1 shifted by ph2 pixels. If ph2<0, then the shift is to the left, but if ph2>0, then the shift is to the right.

Then, the controller and memory unit 20 repeats the procedure, for the next view.

### Boundaries

The image process based, dynamically adjusting vehicle surveillance system for intersection traffic of Example 1 may set a right limit portion, PR, and not allow portions pass to the right of PR by ignoring ph contributions that would push the portion pass to the right of PR. Similarly, the image process based, dynamically adjusting vehicle surveillance system for intersection traffic of Example 1 may set a left limit portion, PL, and not allow portions pass to the left of PL by ignoring ph contributions that would push the portion pass to the left of PL.

Therefore, the monitor 30 provides a driver of the vehicle with the desired key views, both while making right turns and while not making right turns. In addition, while making a right turn, the monitor 30 provides a view that is generally in a consistent direction throughout the turn.

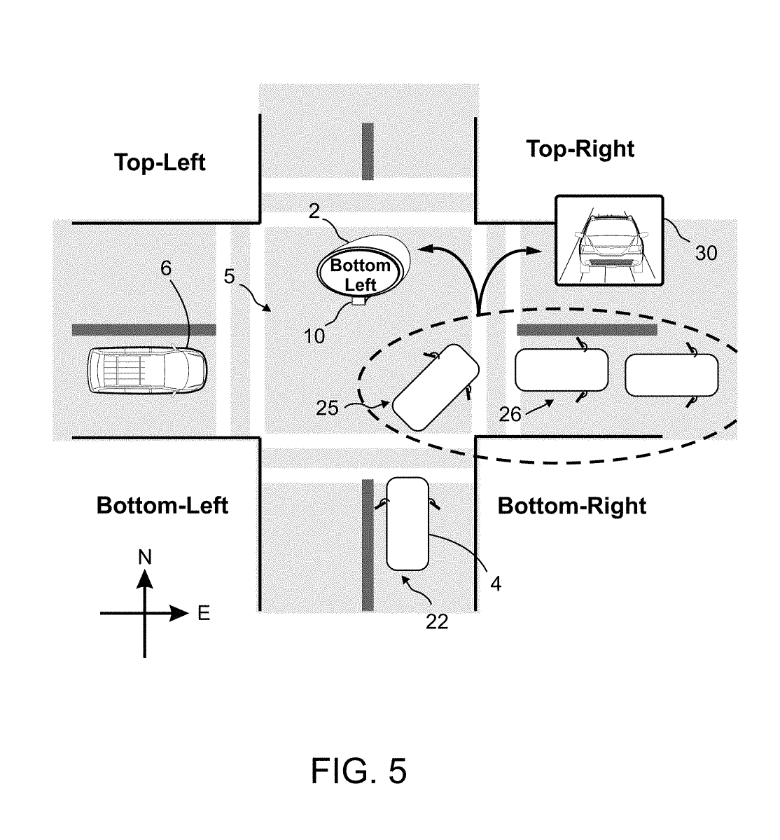

FIG. 5 depicts an application of the image process based, dynamically adjusting vehicle surveillance system for intersection traffic of Example 1. The automobile 4 is depicted in three positions: facing north at the intersection 5 (position 22), facing north-east in the intersection 5 (position 25), and facing east past the intersection 5 (position 26). During most of the right turn, the left-side mirror 2 shows the bottom left corner of the intersection. Instead, the monitor 30 shows a view of the cross traffic from west in a generally consistent manner. The view of the monitor 30 does not rotate with the automobile 4, hence providing useful surveillance. In FIG. 5, the view of the cross traffic from west includes a view of an automobile 6.

### How to Terminate a Right Turn

The controller and memory unit 20 ends a right turn and starts displaying a left-side mirror view on the monitor 30 when at least one of the following conditions is detected: 1) if street lines indicate end of a right turn, for example if a dashed white line is detected lining up with the vehicle; 2) if a selected portion at time n, during a right turn equals PA; 3) if a right turn takes longer than a predetermined time, N1; and 4) if the total changes in the angular position of the vehicle in the last N2 indices is less than alpha2, where N2 and alpha2 are predetermined values.

After detecting one of the above conditions, if the last portion, P, is not already the same as PA, then the controller and memory unit 20 gradually moves the portions to position PA.

Anyone of the above conditions may be used by itself without including the other conditions. To increase accuracy one may combine the above conditions or add more conditions.

### Flow Chart

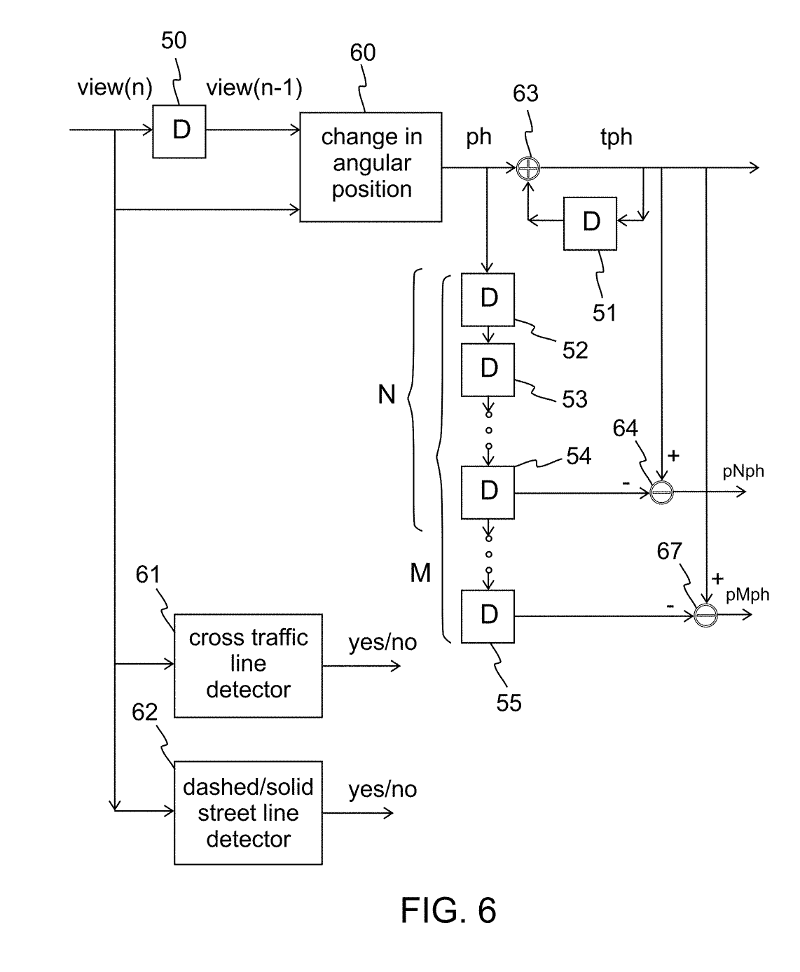

Overall operation of the image process based, dynamically adjusting vehicle surveillance system for intersection traffic of Example 1 may be summarized using FIG. 6 and Table 1.

The block diagram of FIG. 6 shows, in more detail, how changes in the angular position, ph, the total changes in the angular position, tph, and the partial changes in the angular position, tNph and tMph, may be computed, and how a “cross traffic line detector” and a “street dashed/solid line detector” may fit in a hardware or software implementation of the image process based, dynamically adjusting vehicle surveillance system for intersection traffic of Example 1.

Boxes labeled 50, 51, 52, 53, 54, and 55 are delay operators. The input to the box 50 is view(n), at time index n. The output of the box 50 is view(n−1), at time index n.

The views, view(n) and view(n−1), are input to a box 60 named “change in angular position”. The box 60 performs the procedure given above and computes the change in angular position, and it outputs, ph.

The box 51 and an adder 63 generate a running sum of the changes in the angular position of the vehicle. The input of the box 51 is the total changes in the angular position, tph.

On the other hand, a subtraction operator 64 together with N delay boxes, of which three are shown, generate the sum of the changes in the angular position over the last N time indices, tNph. The delay boxes shown are 52, 53, and 54.

Also a subtraction operator 67 together with M delay boxes, of which four are shown, generate the sum of the changes in the angular position over the last M time indices, tMph. The delay boxes shown are 52, 53, 54, and 55.

The view, view(n), is input to a box 61 named “cross traffic line detector”. The box 61 generates a binary output indicating whether a cross traffic line is detected or not. The box 61 performs the task given earlier.

The view, view(n), is input to another box 62 named “street dashed/solid line detector”. The box 62 generates a binary output indicating whether a street dashed or solid line is detected lining up with the vehicle or not. The box 62 performs the task given earlier.

The rest of the operation of the image process based, dynamically adjusting vehicle surveillance system for intersection traffic of Example 1 may be described using Table 1.

Table 1 gives a finite state transition machine, FSTM, with three states: 1, 2, and 3.

If the state=1, it means the FSTM is processing a “not making a right turn” by the vehicle.

If the state=2, it means the FSTM, is processing a “making a right turn” by the vehicle.

If the state=3, it means the FSTM, is processing a termination to a “making a right turn” by the vehicle. In this state, the FSTM returns the selected portions, P's, to PA.

For a given row, the column 2 gives the current state of the FSTM.

For a given row, the column 3 is yes if one of the following 4 conditions is satisfied, otherwise it is a no.

Condition 1: A counter “con1” has reached N1.

Condition 2: The previous selected portion, PX, equals PA.

Condition 3: Referring to FIG. 6, the box 62 output is yes.

Condition 4: A counter “con2” has reached N2 AND abs(tNph) of FIG. 6 is less than alpha2.

For a given row, the column 4 is yes if the following condition is satisfied, otherwise it is a no.

Condition 5: Referring to FIG. 6, the box 61 output is yes AND tMph is greater than alpha1.

For a given row, the column 5 is yes if the following condition is satisfied, otherwise it is a no.

Condition 2: The previous selected portion, PX, equals PA.

For a given row, the column 6 gives the next state of the FSTM.

For a given row, the column 7 gives the next selected portion.

For a given row, the column 8 states whether the counter con1 should be incremented or reset to zero or put to sleep.

For a given row, the column 9 states whether the counter con2 should be incremented or reset to zero or put to sleep.

TABLE 1

| 1 | 2 | 3 | 4 | 5 | 6 | 7 | 8 | 9 |
|---|---|---|---|---|---|---|---|---|
| 1 | 1 | | N | | 1 | PA | NA | NA |
| 2 | 1 | | Y | | 2 | PB | 0 | 0 |
| 3 | 2 | N | | | 2 | SHIFT(PX, ph; PA) | add 1 | add 1 |
| 4 | 2 | Y | | Y | 1 | PA | NA | NA |
| 5 | 2 | Y | | N | 3 | SHIFT(PX, PH; PA) | NA | NA |
| 6 | 3 | | | N | 3 | SHIFT(PX, PH; PA) | NA | NA |
| 7 | 3 | | | Y | 1 | PA | NA | NA |

The rows of Table 1 are defined as follows:

Row 1: If the current state is 1, then columns 3 and 5 are not relevant. If the column 4 is no (no right turn is detected), then the next state is 1 (column 6) and the next selected region is PA (corresponds to left side mirror view, column 7). The counter con1 is sleep (column 8) and the counter con2 is sleep (column 9).

Row 2: If the current state is 1, then columns 3 and 5 are not relevant. If the column 4 is yes (right turn is detected), then the next state is 2 (column 6) and the next selected region is PB (corresponds to cross traffic from the left side, column 7). The counter con1 is reset to zero (column 8) and the counter con2 is reset to zero (column 9).

Row 3: If the current state is 2, then column 4 is not relevant. If the column 3 is no (tail of right turn is detected), then column 5 is not relevant. Then the next state is 2 (column 6) and the next selected region is PX=SHIFT(PX,ph; PA) (column 7), where SHIFT(PX,ph; PA) is a function that takes the region PX and moves it horizontally by ph pixels; if at any time during the move the region coincides with PA, then SHIFT(PX,ph; PA)=PA. The counter con1 is incremented (column 8) and the counter con2 is incremented (column 9).

Row 4: If the current state is 2, then column 4 is not relevant. If the column 3 is yes (tail of right turn is detected), and the previous selected portion, PX, was equal to PA (column 5), then the next state is 1 (column 6) and the next selected region is PX=PA (column 7). The counter con1 is put to sleep (column 8) and the counter con2 is put to sleep (column 9).

Row 5: If the current state is 2, then column 4 is not relevant. If the column 3 is yes (tail of right turn is detected), and the previous selected portion, PX, was not equal to PA (column 5), then the next state is 3 (column 6) and the next selected region is PX=SHIFT(PX,PH; PA) (column 7), where PH is a predetermined change in the angular position. The counter con1 is put to sleep (column 8) and the counter con2 is put to sleep (column 9).

Row 6: If the current state is 3, then columns 3 and 4 are not relevant. If the previous selected portion, PX, was not equal to PA (column 5), then the next state is 3 (column 6) and the next selected region is SHIFT(PX,PH; PA) (column 7). The counter con1 remains sleep (column 8) and the counter con2 remains sleep (column 9).

Row 7: If the current state is 3, then columns 3 and 4 are not relevant. If the previous selected portion, PX, was equal to PA (column 5), then the next state is 1 (column 6) and the next selected region is PX=PA (column 7). The counter con1 remains sleep (column 8) and the counter con2 remains sleep (column 9).

### EXAMPLE 2

Example 2 is explained using FIGS. 3, 6 and 9.

This example relates to scenario A1—referring to a view in the right-side mirror during left turn. More specifically, an image process based, dynamically adjusting vehicle surveillance system for intersection traffic of Example 2 alleviates the shortcomings of the right-side mirror during left turns as explained earlier.

Here the key desired view is a view of a right-side mirror when the vehicle is not turning left at an intersection, and the desired view is a view of a road section opposite to that of the road section into which the vehicle is turning; that is, a view of the cross traffic from the right side when the vehicle is turning left at an intersection.

FIG. 3 gives a block diagram of the image process based, dynamically adjusting vehicle surveillance system for intersection traffic of Example 2. The image process based, dynamically adjusting vehicle surveillance system for intersection traffic of Example 2 includes the camera 10, the controller and memory unit 20, and the monitor 30.

Again, the controller and memory unit 20 is configured to receive the sequence of the views: view(1), view(2) and so on, that are captured by the camera 10.

When the vehicle is not making a left turn at an intersection, the controller and memory unit 20 selects portions P1, P2, and so on, of the views, view(1), view(2), and so on, respectively, such that Pi's are views of a right-side mirror. Then, the controller and memory unit 20 displays portions P1, P2, and so on, on the monitor 30. The monitor 30 provides these views to the driver of the vehicle.

When the vehicle is making a left turn at an intersection, the controller and memory unit 20 selects portions P1, P2, and so on, of the views, view(1), view(2), and so on, respectively, such that Pi's are views of a cross traffic from the right side.

Next the controller and memory unit 20 displays portions P1, P2, and so on, on the monitor 30. The monitor 30 provides these views for the driver of the vehicle.

How Pi potions are selected will be explained below.

### Angular Position Changes

The controller and memory unit 20 is configured to measure the changes in angular position of the vehicle as in Example 1.

How a left turn is detected will be explained below.

The controller and memory unit 20 is configured to detect the following two conditions.

1) Total changes in the angular position of the vehicle exceeds in magnitude a predetermined angle, alpha1, for example alpha1=45 degrees, and

2) A change in the street lines indication entering an intersection.

A left turn by the vehicle is detected by the controller and memory unit 20 when one or both conditions above are detected.

The condition 2) above prevents a sharp turn that is not part of a left turn to be marked as a left turn by the controller and memory unit 20. Nevertheless, since the vehicle does not encounter many sharp turns during normal driving conditions, the second condition may be eliminated. However, it has been kept for extra accuracy.

### How to Select Portions (P1, P2, and so on)

When a left turn is not detected, more specifically, the controller and memory unit 20 selects P1=PC, P2=PC, and so on, where PC is a predetermined area in the view of the camera 10 that corresponds to a view of a typical right-side mirror

When a left turn is detected, more specifically, the controller and memory unit 20 first selects P1=PD, where PD is a predetermined area in the view(1) of the camera 10 that corresponds to a view of a typical cross traffic from right side from a vehicle that has completed alpha1 degrees rotation into its left turn.

After receiving, view(2), the controller and memory unit 20 measures the change in angular position of the vehicle from position in view(1) to position in view(2). The change in angular position can be denoted by ph2. Next, the controller and memory unit 20 defines

P2=SHIFT(P1,ph2), that is the portion P2 is P1 shifted by ph2 pixels. If ph2<0, then the shift is to the left, but if ph2>0, then the shift is to the right.

Then, the controller and memory unit 20 repeats the procedure, for the next view.

Therefore, the monitor 30 provides a driver of the vehicle with the desired key views, both while making left turns and while not making left turns. In addition, while making a left turn, the monitor 30 provides a view that is generally in a consistent direction throughout the turn.

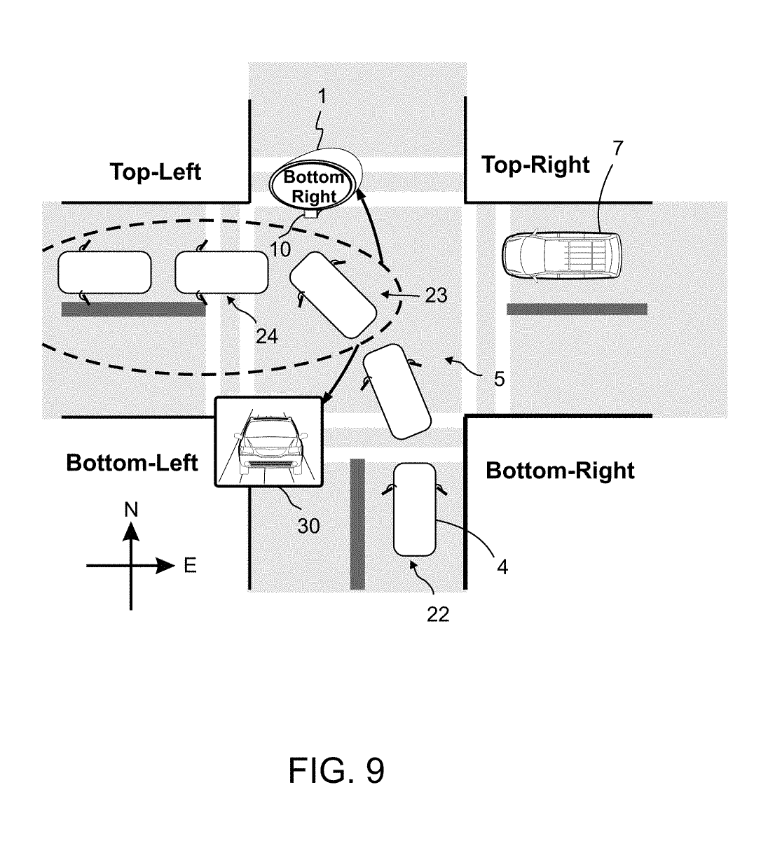

FIG. 9 depicts an application of the image process based, dynamically adjusting vehicle surveillance system for intersection traffic of Example 2. The automobile 4 is depicted in three positions: facing north at the intersection 5 (position 22), facing north-west in the intersection 5 (position 23), and facing west past the intersection 5 (position 24). During most of the left turn, the right-side mirror 1 shows the bottom right corner of the intersection. Instead the monitor 30 shows a view of the cross traffic from east in a generally consistent manner. The view of the monitor 30 does not rotate with the automobile 4, hence providing useful surveillance. In FIG. 9, the view of the cross traffic from east includes a view of an automobile 7.

### How to Terminate a Left Turn

The controller and memory unit 20 ends a left turn and starts displaying a right-side mirror view on the monitor 30 when one of the following conditions is detected: 1) if street lines indicate end of a left turn, for example if a dashed/sold white line is detected lining up with the vehicle; 2) if a selected portion at time n, during a left turn equals PC; 3) if a left turn takes longer than a predetermined time, N1; and 4) if the total changes in the angular position of the vehicle in the last N2 indices is less than alpha2, where N2 and alpha2 are predetermined values.

After detecting one of the above conditions, if the last portion, P, is not already the same as PC, then the controller and memory unit 20 gradually moves the portions to position PC.

Anyone of the above conditions may be used by itself without including the other conditions. To increase accuracy one may combine the above conditions or add more conditions.

### Flow Chart

Overall operation of the image process based, dynamically adjusting vehicle surveillance system for intersection traffic of Example 2 may be summarized using the summary of Example 1, FIG. 6 and Table 1, by interchanging the following names and words: PA to PC, PB to PD, right to left, and left to right.

### EXAMPLE 3

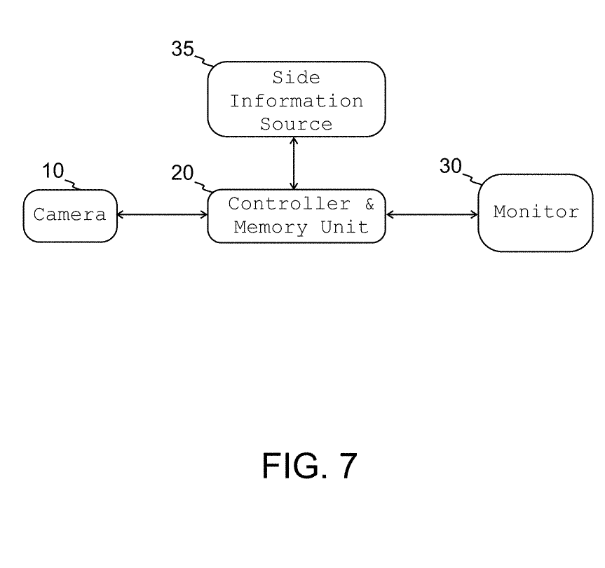

Example 3 is explained using FIGS. 7, 10, and 8.

This example relates to scenario A3—referring to a view in the left-side mirror during left turn. More specifically, an image process based, dynamically adjusting vehicle surveillance system for intersection traffic of Example 3 alleviates the shortcomings of the left-side mirror during left turns as explained earlier.

Here the key desired view is a view of a left-side mirror when the vehicle is not turning left at an intersection, and the desired view is a view of a road section toward behind the vehicle on the left side before a turn is initiated when the vehicle is turning left at an intersection.

FIG. 7 gives a block diagram of the image process based, dynamically adjusting vehicle surveillance system for intersection traffic of Example 3. The image process based, dynamically adjusting vehicle surveillance system for intersection traffic of Example 3 includes the camera 10, the controller and memory unit 20, the monitor 30, and a side information source 35.

The connectivity of the camera 10, the controller and memory unit 20 and the monitor 30 are as described previously. In Example 3, the side information source 35 is connected to the controller and memory unit 30. In addition, the side information source 35 is a left side signal switch.

The camera 10 captures a sequence of views: view(1), view(2) and so on. The controller and memory unit 20 receives the sequence of the views: view(1), view(2) and so on.

When the vehicle is not making a left turn at an intersection, the controller and memory unit 20 selects portions P1, P2, and so on, of the views, view(1), view(2), and so on, respectively, such that Pi's are views of a left-side mirror. Then, the controller and memory unit 20 displays portions P1, P2, and so on, on the monitor 30. The monitor 30 provides these views to the driver of the vehicle.

When the vehicle is making a left turn at an intersection, the controller and memory unit 20 selects portions P1, P2, and so on, of the views, view(1), view(2), and so on, respectively, such that Pi's are views of a road section toward behind the vehicle on the left side before a turn is initiated.

Next the controller and memory unit 20 displays portions P1, P2, and so on, on the monitor 30. The monitor 30 provides these views for the driver of the vehicle.

How Pi potions are selected will be explained below.

### Angular Position Changes

The controller and memory unit 20 is configured to measure the changes in angular position of the vehicle as in Example 1.

How a left turn is detected will be explained below.

The controller and memory unit 20 is configured to detect the following condition.

1) A left turn signal.

### How to Select Portions (P1, P2, and so on)

When a left turn is not detected, more specifically, the controller and memory unit 20 selects P1=PA, P2=PA, and so on, where PA is the predetermined area in the view of the camera 10 that corresponds to a view of a typical left-side mirror.

When a left turn is detected, more specifically, the controller and memory unit 20 initially keeps P1=PA. After receiving view(2), the controller and memory unit 20 measures the change in angular position of the vehicle from position in view(1) to position in view(2). The change in angular position can be denoted by ph2. Next, the controller and memory unit 20 defines P2=SHIFT(P1,ph2), that is the portion P2 is P1 shifted by ph2 pixels. If ph2<0, then the shift is to the left, but if ph2>0, then the shift is to the right.

Then, the controller and memory unit 20 repeats the procedure, for the next view.

Therefore, the monitor 30 provides a driver of the vehicle with the desired key views, both while making left turns and while not making left turns. In addition, while making a left turn, the monitor 30 provides a view that is generally in a consistent direction throughout most of the turn.

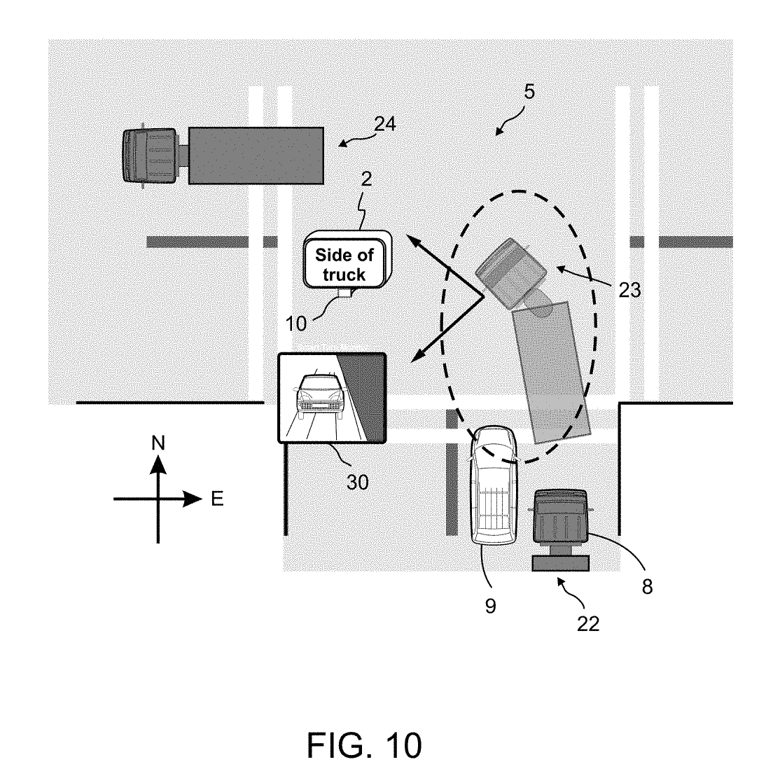

FIG. 10 depicts an application of the image process based, dynamically adjusting vehicle surveillance system for intersection traffic of Example 3. The trailer-truck 8 is depicted in three positions: facing north at the intersection 5 (position 22), facing north-west in the intersection 5 (position 23), and facing west past the intersection 5 (position 24).

During most of the left turn, the left-side mirror 2 shows the body of the trailer-truck 8 on the left side. Instead the monitor 30 shows a view of the road section toward behind the vehicle on the left side before a turn is initiated. In FIG. 10, there is an automobile 9 on the left side of the trailer-truck 8. The automobile 9 is in danger because it is not in the view of the driver of the trailer-truck 8. However, the automobile 9 is in the view of the monitor 30, since most of the view of the dynamically adjusting vehicle surveillance system for intersection traffic of Example 3 is toward south in a generally consistent manner.

### How to Terminate a Left Turn

The controller and memory unit 20 ends a left turn and starts displaying a left-side mirror view on the monitor 30 when one of the following conditions is detected:
1. If the magnitude of total changes in the angular position of the vehicle exceeds alpha5, where alpha5 is a predetermined value, for example 45 degrees.
2. If the left turn signal is turned off.

After detecting any of the above conditions, the controller and memory unit 20 moves the portions to position PA again.

### Flow Chart

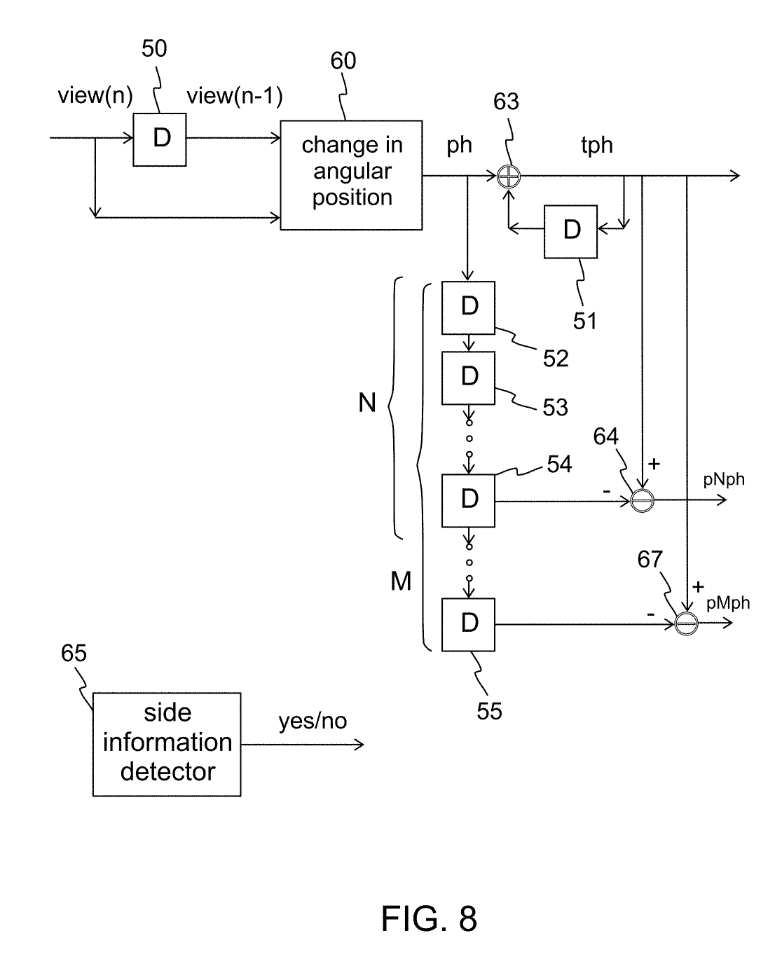

Overall operation of the image process based, dynamically adjusting vehicle surveillance system for intersection traffic of Example 3 may be summarized using FIG. 8 and Table 2.

FIG. 8 differs from FIG. 6 in that instead of the boxes 61 and 62, FIG. 8 has a box 65 named “side information detector”.

Outputs: ph, tph, tNph, and tMph are generated exactly the same way as in FIG. 6, where ph is the change in angular position in one step, tph is the total change in angular position, tpNph is the total change in angular position in the last N step, and tpMph is the total change in angular position in the last M step.

The output of the box 65 named “side information detector” is a binary signal yes/no (or 0/1). In Example 3, the side information comes from the left side signal switch. If the switch is on, the output of the box 65 is yes, but if the switch is off, then the output of the box 65 is no.

The rest of the operation of the image process based, dynamically adjusting, intersection traffic, vehicle surveillance system of Example 3 may be described using Table 2.

Table 2 gives a finite state transition machine, FSTM, with two states: 1, 2.

If the state=1, it means the FSTM is processing a “not making a left turn” by the vehicle.

If the state=2, it means the FSTM, is processing a “making a left turn” by the vehicle.

For a given row, the column 2 gives the current state of the FSTM.

For a given row, the column 3 is yes if one of the following 2 conditions is satisfied, otherwise it is a no.

Condition 1: Referring to FIG. 8, the box 65 output is no.

Condition 2: The abs(tMph) of FIG. 8 is greater than alpha5.

For a given row, the column 4 is yes if the following condition is satisfied, otherwise it is a no.

Condition 1: Referring to FIG. 8, the box 65 output is yes.

For a given row, the column 5 gives the next state of the FSTM.

For a given row, the column 6 gives the next selected portion.

TABLE 2

| 1 | 2 | 3 | 4 | 5 | 6 |
|---|---|---|---|---|---|
| 1 | 1 | | N | 1 | PA |
| 2 | 1 | | Y | 2 | PA |
| 3 | 2 | N | | 2 | SHIFT(PX, ph) |
| 4 | 2 | Y | | 1 | PA |

The rows of Table 2 can be described as follows.

Row 1: If the current state is 1, then column 3 is not relevant. If the column 4 is no (no left turn signal), then the next state is 1 (column 5) and the next selected region is PA (corresponds to left side mirror view, column 6).

Row 2: If the current state is 1, then column 3 is not relevant. If the column 4 is yes (left turn signal detected), then the next state is 2 (column 5) and the next selected region is PA (column 6).

Row 3: If the current state is 2, then column 4 is not relevant. If the column 3 is no, then the next state is 2 (column 5) and the next selected region is PX=SHIFT(PX,ph) (column 6).

Row 4: If the current state is 2, then column 4 is not relevant. If the column 3 is yes, then the next state is 1 (column 5) and the next selected region is PX=PA (column 6).

### EXAMPLE 4

Example 4 is explained using FIGS. 7, 11, and 8.

This example relates to scenario A2—referring to a view in the right-side mirror during right turn. More specifically, an image process based, dynamically adjusting vehicle surveillance system for intersection traffic of Example 4 alleviates the shortcomings of the right-side mirror during right turns as explained earlier.

Here the key desired view is a view of a right-side mirror when the vehicle is not turning right at an intersection, and the desired view is a view of a road section toward behind the vehicle on the right side before a turn is initiated when the vehicle is turning right at an intersection.

An image process based, image process based, dynamically adjusting vehicle surveillance system for intersection traffic of example 4 comprises the camera 10, the controller and memory unit 20, the monitor 30, and the side information source 35 of FIG. 7.

In Example 4, the side information source 35 is a GPS unit.

The camera 10 captures a sequence of views: view(1), view(2), and so on. The controller and memory unit 20 receives the sequence of the views: view(1), view(2) and so on.

When the vehicle is not making a right turn at an intersection, the controller and memory unit 20 selects portions P1, P2, and so on, of the views, view(1), view(2), and so on, respectively, such that Pi's are views of a right-side mirror, next the controller and memory unit 20 displays portions P1, P2, and so on, on the monitor 30. The monitor 30 provides these views to the driver of the vehicle.

When the vehicle is making a right turn at an intersection, the controller and memory unit 20 selects portions P1, P2, and so on, of the views, view(1), view(2), and so on, respectively, such that Pi's are views of a road section toward behind the vehicle on the right side before a turn is initiated.

Next the controller and memory unit 20 displays portions P1, P2, and so on, on the monitor 30. The monitor 30 provides these views for the driver of the vehicle.

How a right turn is detected will be explained below.

The controller and memory unit 20 is configured to detect the following condition.

1) GPS signals indicating proximity to the intersection and direction of turn (right turn for example 4).

### How to Select Portions (P1, P2, and so on)

When a right turn is not detected, more specifically, the controller and memory unit 20 selects P1=PC, P2=PC, so on, where PC is the predetermined area in the view of the camera 10 that corresponds to a view of a typical right-side mirror.

When a right turn is detected, more specifically, the controller and memory unit 20 initially keeps P1=PC. After receiving, view(2), the controller and memory unit 20 measures the change in angular position of the vehicle from position in view(1) to position in view(2). The change of angular position can be denoted by ph2. Next, the controller and memory unit 20 defines P2=SHIFT(P1,ph2), that is the portion P2 is P1 shifted by ph2 pixels. If ph2<0, then the shift is to the left, but if ph2>0, then the shift is to the right.

Then, the controller and memory unit 20 repeats the procedure, for the next view.

Therefore, the monitor 30 provides a driver of the vehicle with the desired key views, both while making right turns and while not making right turns. In addition, while making a right turn, the monitor 30 provides a view that is generally in a consistent direction throughout most of the turn.

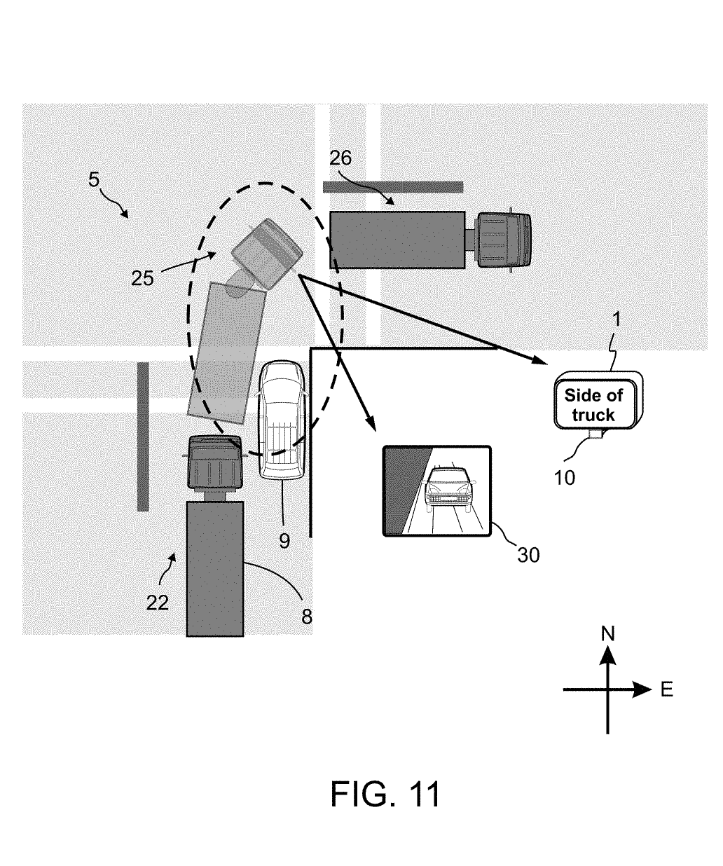

FIG. 11 depicts an application of the image process based, dynamically adjusting vehicle surveillance system for intersection traffic of Example 4. The trailer-truck 8 is depicted in three positions: facing north at the intersection 5 (position 22), facing north-east in the intersection 5 (position 25), and facing east past the intersection 5 (position 26).

During most of the right turn, the right-side mirror 1 shows the body of the trailer-truck 8 on the right side. Instead, the monitor 30 shows a view of the road section toward behind the vehicle on the right side before a turn is initiated. In FIG. 11, there is the automobile 9 on the right side of the trailer-truck 8. The automobile 9 is in danger because it is not in the view of the driver of the trailer-truck 8. However, the automobile 9 is in the view of the monitor 30, since most of the view of the dynamically adjusting vehicle surveillance system for intersection traffic of Example 4 is toward south in a generally consistent manner.

### How to Terminate a Right Turn

The controller and memory unit 20 ends a right turn and starts displaying a right-side mirror view on the monitor 30 when one of the following conditions is detected:
1. If the magnitude of total changes in the angular position of the vehicle exceeds alpha5, where alpha5 is a predetermined value, for example 45 degrees.
2. If a timer runs out. The duration of the timer is predetermined.

After detecting any of the above condition, the controller and memory unit 20 moves the portions to position PC again.

### Flow Chart

Overall operation of the image process based, image process based, dynamically adjusting vehicle surveillance system for intersection traffic of Example 4 may be summarized using FIG. 8 and Table 3.

The description of FIG. 8 of Example 3 directly applies to Example 4, except the side information of the box 65 are GPS signals indicating proximity to the intersection and direction of turn (right turn for Example 4). If the GPS signal are received then the output of the box is ‘yes’, otherwise it is ‘no’.

The rest of the operation of the image process based, image process based, dynamically adjusting vehicle surveillance system for intersection traffic of Example 4 may be described using Table 3.

Table 3 gives a finite state transition machine, FSTM, with two states: 1, 2.

If the state=1, it means the FSTM is processing a “not making a right turn” by the vehicle.

If the state=2, it means the FSTM, is processing a “making a right turn” by the vehicle.

For a given row, the column 2 gives the current state of the FSTM.

For a given row, the column 3 is yes if one of the following 2 conditions is satisfied, otherwise it is a no.

Condition 1: A counter, con0=N0, N0 a predetermined value.

Condition 2: The abs(tMph) of FIG. 8 is greater than alpha5.

For a given row, the column 4 is yes if the following condition is satisfied, otherwise it is a no.

Condition 1: Referring to FIG. 8, the box 65 output is yes; detection of GPS signals indicating proximity of the vehicle to the intersection and the direction of turn (right turn for example 4).

For a given row, the column 5 gives the next state of the FSTM.

For a given row, the column 6 gives the next selected portion.

For a given row, the column 7 states whether the counter con0 should be incremented or reset to zero or put to sleep.

TABLE 3

| 1 | 2 | 3 | 4 | 5 | 6 | 7 |
|---|---|---|---|---|---|---|
| 1 | 1 | | N | 1 | PC | Null |
| 2 | 1 | | Y | 2 | PC | 0 |
| 3 | 2 | N | | 2 | SHIFT(PX, ph) | Add 1 |
| 4 | 2 | Y | | 1 | PC | Null |

The rows of Table 3 can be defined as follows.

Row 1: If the current state is 1, then column 3 is not relevant. If the column 4 is no (no GPS signals for proximity and direction of turn), then the next state is 1 (column 5) and the next selected region is PC (corresponds to right side mirror view, column 6). The counter con0 is in sleep mode (column 7).

Row 2: If the current state is 1, then column 3 is not relevant. If the column 4 is yes (GPS signals for proximity and direction of turn), then the next state is 2 (column 5) and the next selected region is PC (column 6). The counter con0 is reset to zero (column 7).

Row 3: If the current state is 2, then column 4 is not relevant. If the column 3 is no, then the next state is 2 (column 5) and the next selected region is PX=SHIFT(PX,ph) (column 6), and counter con0 is incremented (column 7).

Row 4: If the current state is 2, then column 4 is not relevant. If the column 3 is yes, then the next state is 1 (column 5) and the next selected region is PX=PC (column 6), and the counter con0 is put to sleep (column 7).

When two image process based, dynamically adjusting vehicle surveillance systems for intersection traffic are used, one for the right side and one for the left side of the automobile, then one may use the views from both sides in the computation of the changes of angular position. That is one may find a rotation that would produce an overall best (on both sides) reproduction to Q1.

The region Q1 does not have to be a connected region, that is, one may use a region Q1 that is a union of two disjoint regions of the view(1).

Examples 1 through 4 apply to automobiles as well as trucks, trailer-trucks and other like vehicles.

The controller and memory unit 20 may do additional image processing to enhance the images it sends to the monitor 30. For example, the controller and memory unit 20 may automatically adjust for brightness and remove vibration (stabilize). The parameter, pv, related to the regions Q1 and Q2, is especially useful to stabilization algorithms.

For very wide angle view of a side of the vehicle, more than one camera may be used on each side. The view would then be a panorama view of the views of the cameras.

All predetermined parameters may be programmable and changeable to serve different users preferences.

Example 3 has a favorable use during lane changes. During lane changes the side mirrors have the same disadvantages they have during turns, but milder. Still, the image process based, dynamically adjusting vehicle surveillance systems for intersection traffic produces more desired and useful views then traditional side mirrors. The key view during a lane change is the view of the traffic in the lane to which a vehicle is moving. As a vehicle is changing lanes, the side mirror view gets weaker with respect to the key view, whereas in the systems of Example 3, the view of the monitor gets stronger with respect to the key view, that is it spans more of the key view.

If GPS is used in Examples 1 and 2, the controller and memory unit 20 may be further configured to incorporate the GPS signals. More specifically, the controller and memory unit 20 may update the position of the selected subsets of the views, P's, based on side information from the GPS. More specifically, PB and PD are adjusted based on the information on the number of lanes, the angle of intersection between the intersecting roads at the intersection, and the like. Also, the controller and memory unit 20 may terminate the dynamically adjusting surveillance system based on information from the GPS.

One may use an image process based, dynamically adjusting vehicle surveillance system to measure the changes in the angular position of the camera 10. To this end, one may use the camera 10 and the controller and memory unit 20, and further use the controller and memory unit 20 to measure the change in the angular position of the camera based on the sequence of views view(1), view(2), and so on.

The dynamically adjusting vehicle surveillance systems may choose, instead of sending the views to a display or the monitor 30, to record them for later analysis.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

The claims are thus to be understood to include what is specifically illustrated and described above, what is conceptually equivalent, what can be obviously substituted and also what incorporates the essential idea of the invention.

What is claimed is:

1. A dynamically adjusting surveillance system comprising:
at least one camera configured to capture a sequence of views containing a key view; and
a controller and memory unit configured to receive the sequence of views, the controller and memory unit further configured, based on the sequence of views, to measure changes in angular position of a vehicle using an image processing technique;
wherein the controller and memory unit selects portions of the sequence of views based on a measured change in angular position of the vehicle, wherein the selected portions contain the key view.

2. The dynamically adjusting surveillance system of claim 1, wherein the view of cross traffic is in a constant direction during the turn.

3. The dynamically adjusting surveillance system of claim 1, further comprising a monitor, wherein the controller and memory unit is further designed to display the selected portions of the sequence of views on the monitor.

4. The dynamically adjusting surveillance system of claim 1, wherein the key view comprises a view of a road section toward behind the vehicle on the left side before a turn is initiated.

5. The dynamically adjusting surveillance system of claim 1, wherein the key view comprises a view of a road section toward behind the vehicle on the right side before a turn is initiated.

6. The dynamically adjusting surveillance system of claim 1, wherein:
two views in the sequence of views are indexed by integers designated view(1) and view(2); and
a change in angular position of the vehicle at index 2 is calculated by taking a portion, Q1, of pixels in a camera view, view(1), at index 1, then finding a best representative, Q2, in the camera view, view(2) at index, 2, and measuring a displacement from Q1 portion to Q2 portion and driving the angular position change based on the displacement.

7. The dynamically adjusting surveillance system of claim 6, wherein the portion, P1, is at close proximity of a vanishing point in the view(1).

8. The dynamically adjusting surveillance system of claim 1, further comprising a Global Positioning System (GPS) providing GPS signals to the controller and memory unit, wherein, for a selection of the portion of the sequence of views, the controller and memory unit is further configured to incorporate the GPS signals.

9. The dynamically adjusting surveillance system of claim 1, further comprising a Global Positioning System (GPS) providing GPS signals to the controller and memory unit, wherein for signaling end of a turn, the controller and memory unit is further configured to incorporate the GPS signals.

10. The dynamically adjusting surveillance system of claim 1, further comprising a Global Positioning System (GPS) providing GPS signals to the controller and memory unit, wherein for signaling the start of a turn, the controller and memory unit is further configured to incorporate the GPS signals.

11. The dynamically adjusting surveillance system of claim 1, further comprising a turn signal switch, wherein the controller and the memory unit is further designed to start a turn when the turn signal switch is on.

12. The dynamically adjusting surveillance system of claim 1, wherein the controller and the memory unit is further designed to start a turn after total changes in angular position exceeds a predetermined angle

13. The dynamically adjusting surveillance system of claim 1, wherein the controller and the memory unit is further designed to start a turn after both following conditions are satisfied: 1) total changes in angular position exceeds a predetermined angle; and 2) the vehicle is at close proximity of an intersection.

14. The dynamically adjusting surveillance system of claim 13, wherein the condition 2) is accomplished by configuring the controller and memory unit to detect the presence and absence of a street traffic line.

15. A dynamically adjusting surveillance system comprising:
at least one camera configured to capture a sequence of views containing a key view;
a controller and memory unit configured to receive the sequence of views, the controller and memory unit further configured, based on the sequence of views, to measure changes in angular position of a vehicle using an image processing technique; and
a monitor, wherein the controller and memory unit is further designed to display the selected portions of the sequence of views on the monitor;
wherein the controller and memory unit selects portions of the sequence of views based on a measured change in angular position of the vehicle, wherein the selected portions contain the key view;
wherein the key view is a rearward view when the vehicle is not turning and is a view of cross traffic from a side opposite which a turn is made at an intersection; and
wherein the view of cross traffic is in a constant direction during the turn.

16. The dynamically adjusting surveillance system of claim 15, wherein:
two views in the sequence of views are indexed by integers designated view(1) and view(2); and
a change in angular position of the vehicle at index 2 is calculated by taking a portion, Q1, of pixels in a camera view, view(1), at index 1, then finding a best representative, Q2, in the camera view, view(2) at index, 2, and measuring a displacement from Q1 portion to Q2 portion and driving the angular position change based on the displacement.

17. The dynamically adjusting surveillance system of claim 15, further comprising:
a Global Positioning System (GPS) providing GPS signals to the controller and memory unit, wherein, for a selection of the portion of the sequence of views, the controller and memory unit is further configured to incorporate the GPS signals;
wherein for signaling end of a turn, the controller and memory unit is further configured to incorporate the GPS signals; and
wherein for signaling the start of a turn, the controller and memory unit is further configured to incorporate the GPS signals.

18. The dynamically adjusting surveillance system of claim 15, further comprising a turn signal switch, wherein the controller and the memory unit is further designed to start a turn when to turn signal switch is on.

19. The dynamically adjusting surveillance system of claim 15, wherein the controller and the memory unit is further designed to start a turn after a first one or a first and second ones of following conditions are satisfied: 1) total changes in angular position exceeds a predetermined angle; and 2) the vehicle is at close proximity of an intersection.

20. The dynamically adjusting surveillance system of claim 19, wherein the condition 2) is accomplished by configuring the controller and memory unit to detect the presence and absence of a street traffic line.

21. A dynamically adjusting surveillance system comprising:
at least one camera configured to capture a sequence of views containing a key view; and
a controller and memory unit configured to receive the sequence of views, the controller and memory unit further configured, based on the sequence of views, to measure changes in angular position of the at least one camera using an image processing technique.

22. The dynamically adjusting surveillance system of claim 21, wherein:
two views in the sequence of views are indexed by integers designated view(1) and view(2); and
a change in angular position of the vehicle at index 2 is calculated by taking a portion, Q1, of pixels in a camera view, view(1), at index 1, then finding a best representative, Q2, in the camera view, view(2) at index, 2, and measuring a displacement from Q1 portion to Q2 portion and driving the angular position change based on the displacement.

23. The dynamically adjusting surveillance system of claim 22, wherein the portion, P1, is at close proximity of a vanishing point in the view(1).
